(19) United States
(12) Patent Application Publication
(10) Pub. No.: US 2016/0170926 A1
(43) Pub. Date: Jun. 16, 2016

(54) APPARATUS, COMPUTER, AND METHOD OF SUPPORTING USB STORAGE DEVICE TO HOT PLUG

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZHENG-SHENG QUE, Wuhan (CN); CHUN-SHENG CHEN, New Taipei (TW)

(21) Appl. No.: 14/606,166

(22) Filed: Jan. 27, 2015

(30) Foreign Application Priority Data
Dec. 16, 2014 (CN) 201410785195.5

(51) Int. Cl. G06F 13/40; G06F 13/38; G06F 11/30

(52) U.S. Cl. CPC G06F 13/4081; G06F 11/3027; G06F 11/3041; G06F 13/385; G06F 13/4027

(57) ABSTRACT

An apparatus configured to support a USB storage device to hot plug when a computer is under a disk operating system is provided. The USB storage device can startup when the computer is under the disk operating system. The apparatus includes a detection unit and a data transmission unit. The detection unit detects whether the USB storage device is connected to a USB interface unit of the computer when the computer is in a disk operating system. The data transmission unit obtains contents in the USB storage device and transmits the content to a south bridge chip of the computer when the USB storage device is connected to the USB interface unit. The disclosed subject matter also provides a computer and a method of supporting a USB storage device to hot plug when the computer is under disk operating system.

### CROSS-REFERENCE TO RELATED APPLICATIONS

This application claims priority to Chinese Patent Application No. 201410785195.5, filed on Dec. 16, 2014, the contents of which are incorporated by reference herein.

### FIELD

The subject matter herein generally relates to a computer supporting a USB storage device to hot plug and a method of supporting a USB storage device to hot plug when a computer is under a disk operating system.

### BACKGROUND

Electronic devices, for example, computers, include universal serial bus (USB) interfaces for connecting USB peripheral devices, such as USB storage devices. When the electronic device is a windows system, the electronic device supports the USB storage device to hot plug. But when the electronic device is a disk operating system, the electronic device only obtains contents of the USB storage device connected to the electronic device before the electronic device is powered. That is, when the electronic device is the disk operating system, the electronic device cannot support the hot plugging of the USB storage device.

### BRIEF DESCRIPTION OF THE DRAWINGS

Implementations of the present technology will now be described, by way of example only, with reference to the attached figures.

FIG. 1 is a block diagram of an apparatus supporting a USB storage device to hot plug when a computer is under a disk operating system.

FIG. 2 is a flowchart of a method of supporting a USB storage device to hot plug when a computer is under a disk operating system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Definitions that apply throughout this disclosure will now be presented.

The term “comprising” means “including, but not necessarily limited to”; it specifically indicates open-ended inclusion or membership in a so-described combination, group, series, and the like.

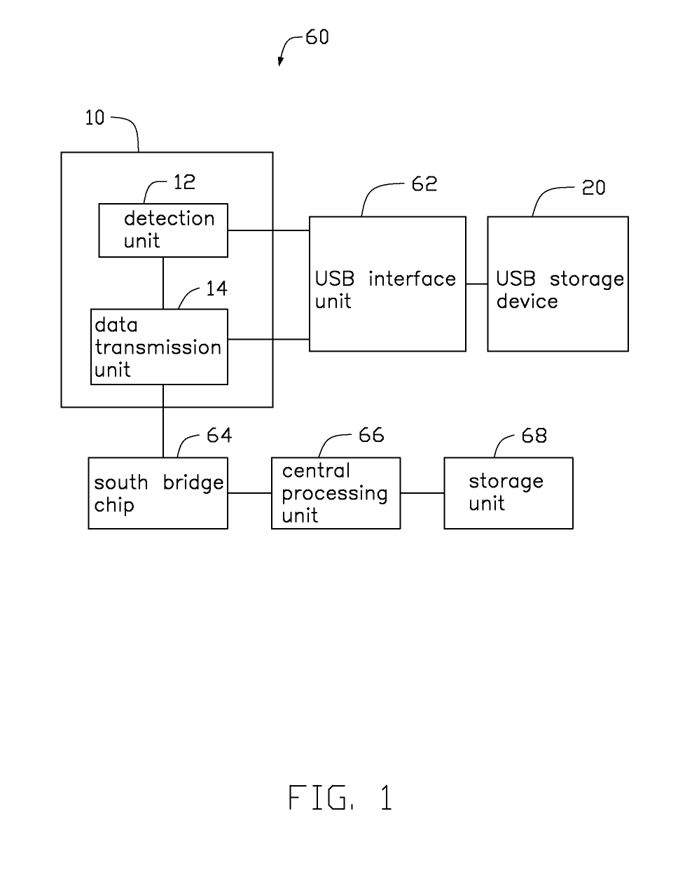

FIG. 1 illustrates an apparatus 10 employed in a computer 60. The apparatus 10 is configured to support a USB storage device 20 to hot plug when the computer 60 is under a disk operating system. The computer 60 includes a USB interface unit 62, a south bridge chip 64, a central processing unit 66 and a storage unit 68. The apparatus 10 includes a detection unit 12 and a data transmission unit 14.

The USB interface unit 62 is configured to connect to the USB storage device 20. The USB storage device 20 can startup when the computer 60 is under the disk operating system. In one embodiment, the USB storage device 20 is derived from a USB flash disk loaded with software named BootFlashDos. The detection unit 12 is configured to detect whether the USB storage device 20 connects to the USB interface unit 62 when the computer 60 is in a disk operating system. In one embodiment, the USB interface unit 62 is a USB 3.0 interface.

The data transmission unit 14 is configured to obtain contents in the USB storage device 20 and transmit the contents to the south bridge chip 64 when the USB storage device 20 connects to the USB interface unit 62. In one embodiment, the data transmission unit 14 includes two pairs of bridging lines. One end of the two pairs of the bridging lines respectively connects two pairs of differential signal lines of the USB interface unit 62. The other end of the two pairs of the bridging lines respectively connects two pairs of differential signal lines of the south bridge chip 64.

The south bridge chip 64 is configured to transmit the contents from the data transmission unit 14 to the central processing unit 66. The central processing unit 66 is configured to write the contents to the storage unit 68. In one embodiment, the storage unit 68 is a memory chip in the computer 60.

In one embodiment, the detection unit 12 includes a detection pin. The detection pin is connected to an output port of a 5V power supply. When the USB storage device 20 is connected to the USB interface unit 62, the detection pin connects to a ground pin of the USB storage device 20. When the USB storage device 20 is disconnected from the USB interface unit 62, the detection unit 12 detects a high level signal. When the USB storage device 20 is connected to the USB interface unit 62, the detection unit 12 detects a low level signal. When the detected level signal is from the high level signal into the low level signal, the data transmission unit 14 obtains and transmits the contents.

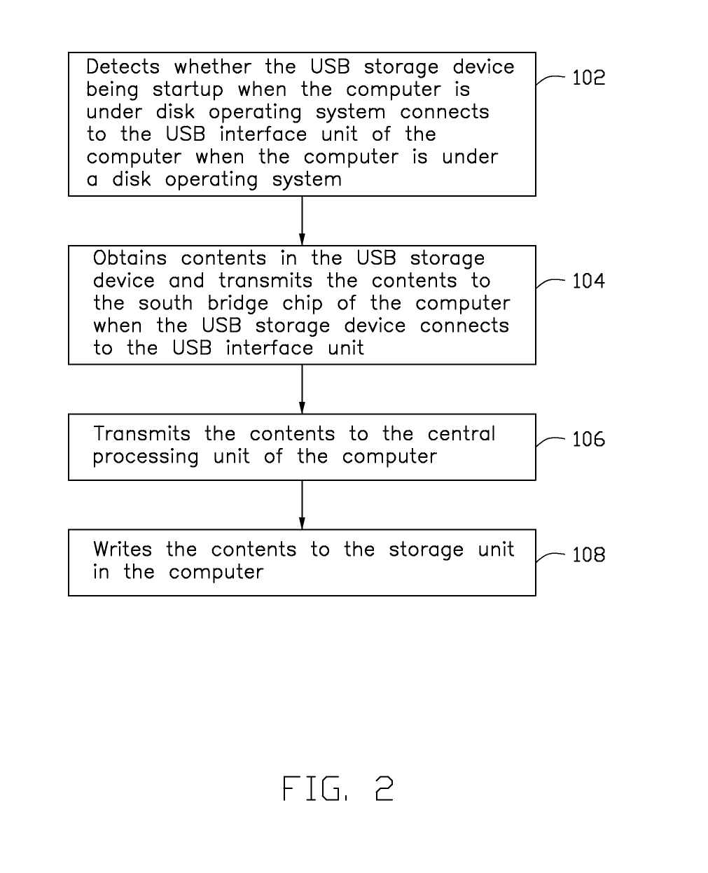

FIG. 2 illustrates a flowchart of a method of supporting a USB storage device to hot plug when a computer is under a disk operating system. The illustrated order of blocks in FIG. 2 is illustrative only and the order of the blocks can change according to the present disclosure. Additional blocks can be added or fewer blocks may be utilized, without departing from this disclosure. The example method can begin at block 102.

At block 102, the detection unit 12 detects whether the USB storage device 20 being capable of being started up when the computer 60 is under disk operating system is connected to the USB interface unit 62 of the computer 60 when the computer 60 is under a disk operating system.

In one embodiment, the detection unit 12 detects whether a detection pin is in a low level to determine whether the USB storage device 20 is connected to the USB interface unit 62. The detection pin connects to an output port of a 5V power supply and connects to a ground pin of the USB storage device 20 when the USB storage device 20 is connected to the USB interface unit 62. When the USB storage device 20 is disconnected from the USB interface unit 62, the detection unit 12 detects a high level signal. When the USB storage device 20 is connected to the USB interface unit 62, the detection unit 12 detects a low level signal. The USB interface unit 62 is a USB 3.0 interface.

At block 104, the data transmission unit 14 obtains contents in the USB storage device 20 and transmits the content to the south bridge chip 64 of the computer 60 when the USB storage device 20 is connected to the USB interface unit 62.

In one embodiment, the content is obtained and transmitted by two pairs of bridging lines. One end of the two pairs of the bridging lines respectively connects two pairs of differential signal lines of the USB interface unit 62. The other end of the two pairs of the bridging lines respectively connects two pairs of differential signal lines of the south bridge chip 64.

At block 106, the south bridge chip 64 transmits the content to the central processing unit 66 of the computer 60.

At block 108, the central processing unit 66 writes the content to the storage unit 68 in the computer 60. In one embodiment, the storage unit 68 is a memory chip in the computer 60.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. An apparatus employed in a computer and configured to support a USB storage device to hot plug, the apparatus comprising:
a detection unit configured to detect whether a USB storage device is connected to a USB interface unit of the computer when the computer is in a disk operating system, the USB storage device being capable of being started up when the computer is under the disk operating system; and
a data transmission unit configured to obtain contents in the USB storage device and transmit the content to a south bridge chip of the computer when the USB storage device is connected to the USB interface unit.

2. The apparatus as claimed in claim 1, wherein the data transmission unit comprises two pairs of bridging lines, one end of the two pairs of the bridging lines respectively connects two pairs of differential signal lines of the USB interface unit, another end of the two pairs of the bridging lines respectively connects two pairs of differential signal lines of a south bridge chip of the computer.

3. The apparatus as claimed in claim 2, wherein the detection unit comprises a detection pin, the detection pin detects whether USB storage device is connected to the USB interface unit.

4. The apparatus as claimed in claim 3, wherein the detection pin is connected to an output port of a power supply in the computer, the detection pin connects to a ground pin of the USB storage device when the USB storage device is connected to the USB interface unit.

5. The apparatus as claimed in claim 4, wherein when the USB storage device is disconnected to the USB interface unit, the detection pin detects a high level signal, when the USB storage device is connected to the USB interface unit, the detection pin detects a low level signal.

6. The apparatus as claimed in claim 5, wherein when a detected level signal detected by the detection pin is from the high level signal into the low level signal, the data transmission unit obtains and transmits the content.

7. The apparatus as claimed in claim 5, wherein the detection pin is connected to an output port of a 5V power supply in the computer.

8. A computer supporting a USB storage device to hot plug, the computer comprising:
a USB interface unit;
a detection unit configured to detect whether a USB storage device is connected to the USB interface unit when the computer is in a disk operating system, the USB storage device being capable of being started up by the computer under the disk operating system;
a data transmission unit configured to obtain contents in the USB storage device and transmit the content when the USB storage device is connected to the USB interface unit.
a south bridge chip configured to receive the content from the data transmission unit;
a storage unit; and
a central processing unit configured to write the content to the storage unit.

9. The computer as claimed in claim 8, wherein the data transmission unit comprises two pairs of bridging lines, one end of the two pairs of the bridging lines respectively connects two pairs of differential signal lines of the USB interface unit, another end of the two pairs of the bridging lines respectively connects two pairs of differential signal lines of a south bridge chip of the computer.

10. The computer as claimed in claim 9, wherein the detection unit comprises a detection pin, the detection pin detects whether USB storage device is connected to the USB interface unit.

11. The computer as claimed in claim 10, wherein the detection pin is connected to an output port of a power supply in the computer, the detection pin connects to a ground pin of the USB storage device when the USB storage device is connected to the USB interface unit.

12. The computer as claimed in claim 11, wherein when the USB storage device is disconnected to the USB interface unit, the detection pin detects a high level signal, when the USB storage device is connected to the USB interface unit, the detection pin detects a low level signal.

13. The computer as claimed in claim 12, wherein when a detected level signal detected by the detection pin is from the high level signal into the low level signal, the data transmission unit obtains and transmits the content.

14. The computer as claimed in claim 12, wherein the detection pin is connected to an output port of a 5V power supply in the computer.

15. The computer as claimed in claim 8, wherein the USB interface unit is a USB 3.0 interface.

16. A method of supporting a USB storage device to hot plug, the method comprising:
detecting whether a USB storage device is connected to a USB interface unit of a computer when the computer is under a disk operating system, the USB storage device being capable of being started up by the computer under the disk operating system; and
obtaining contents in the USB storage device and transmitting the content to a south bridge chip of the computer when the USB storage device is connected to the USB interface unit.

17. The method as claimed in claim 16, wherein detecting whether a detection pin is in a low level to determine whether the USB storage device is connected to the USB interface unit, the detection pin connects to an output port of a power supply and connects to a ground pin of the USB storage device when the USB storage device is connected to the USB interface unit.

18. The method as claimed in claim 16, wherein the contents is obtained and transmitted by two pairs of bridging lines, one end of the two pairs of the bridging lines respectively connects two pairs of differential signal lines of the USB interface unit, another end of the two pairs of the bridging lines respectively connects two pairs of differential signal lines of the south bridge chip.

19. A method as claimed in claim 16, further comprising:
transmitting the content to a central processing unit of the computer by the south bridge chip.

20. A method as claimed in claim 19, further comprising:
writing the content to a storage unit in the computer through the central processing unit.
